(19) United States
(12) Patent Application Publication
(10) Pub. No.: US 2002/0012789 A1
(43) Pub. Date: Jan. 31, 2002

(54) Transparent conductive film and method for producing the same

(75) Inventor: Tadayoshi Iijima, Saku-shi (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: TDK CORPORATION

(21) Appl. No.: 09/748,188

(22) Filed: Dec. 27, 2000

(30) Foreign Application Priority Data
Dec. 28, 1999 (JP) PAT. 11-372786
May 17, 2000 (JP) PAT.2000-145575
May 19, 2000 (JP) PAT. 2000-147400

(51) Int. Cl. B32B 5/16

(52) U.S. Cl. 428/328; 428/421

(57) ABSTRACT

A transparent conductive film with a low electric resistance value and little scattering obtained by an application method, and a method for producing the transparent conductive film are provided.

A transparent conductive film comprising a compressed layer (12) of conductive fine particles obtained by compressing a layer containing conductive fine particles that is formed by application onto a support (14), wherein the compressed layer of the conductive fine particles contains a resin at the time of compression, the resin being contained at an amount of 73 parts by volume or less with respect to 100 parts by volume of the conductive fine particles as represented by volume, and the compressed layer of the conductive fine particles is impregnated with a transparent substance after compression. The layer containing the conductive fine particles is formed by applying a dispersion liquid, which contains the conductive fine particles and the resin, onto the support and drying the liquid, the resin being contained at an amount of 73 parts by volume or less with respect to 100 parts by volume of the conductive fine particles in the dispersion liquid as represented by volume before dispersion.

### BACKGROUND OF THE INVENTION

1. Field of the Invention

The present invention relates to a transparent electrical conductive film and a method for producing the same. The transparent electrical conductive film can be used as a transparent electrode such as an electroluminescence panel electrode, an electrochromic element electrode, a liquid crystal electrode, a transparent plane heater, or a touch panel, and also as a transparent electromagnetic-wave shielding film.

In particular, the transparent electrical conductive film of the present invention is suitable for usage that requires a reduced degree of scattering, such as a transparent plane heater or a touch panel.

2. Disclosure of the Related Art

At present, transparent conductive film is produced mainly by the sputtering method. There are various modes for the sputtering method, for example, a method of forming a film by allowing inert gas ions, which are generated by direct current or high-frequency discharge, to be accelerated to hit the surface of a target in vacuum so as to strike out atoms constituting the target from the surface for deposition on the substrate surface.

The sputtering method is excellent in that a conductive film having a low surface electric resistance can be formed even if it has a large area to some extent. However, it has a disadvantage that the apparatus is large, and the film forming speed is slow. If the conductive film is to have a still larger area from now on, the apparatus will be further enlarged. This raises a technical problem such that the controlling precision must be heightened and, from another point of view, raises a problem of increase in the production cost. Further, although the number of targets is increased to raise the speed in order to compensate for the slowness of the film forming speed, this also is a factor that enlarges the apparatus, thereby raising a problem.

An attempt is made to produce a transparent conductive film by the application method. In a conventional application method, a conductive paint having conductive fine particles dispersed in a binder solution is applied onto a substrate, dried, and hardened to form a conductive film. The application method has an advantage in that a conductive film having a large area can be easily formed, that the apparatus is simple and has a high productivity, and that the conductive film can be produced at a lower cost than by the sputtering method. In the application method, an electric path is formed by contact of the conductive fine particles with each other, whereby the electric conductivity is exhibited. However, the conductive film produced by the conventional application method has an insufficient contact, and the obtained conductive film has a high electric resistance value (i.e. is inferior in conductivity), thereby limiting its usage.

As the production of a transparent conductive film by a conventional application method, Japanese Laid-open Patent Publication No. 9-109259(1997) discloses a production method comprising the first step of applying a paint comprising a conductive powder and a binder resin onto a plastic film for transcription and drying it to form a conductive layer, the second step of pressing (5 to 100 kg/cm²) the conductive layer surface on a smooth surface and heating (70 to 180° C.), and the third step of laminating this conductive layer on a plastic film or sheet and heat-press-bonding it.

In this method, a large amount of binder resin is used (100 to 500 parts by weight of conductive powder with respect to 100 parts by weight of binder in the case of inorganic conductive powder; 0.1 to 30 parts by weight of conductive powder with respect to 100 parts by weight of binder in the case of organic conductive powder), so that a transparent conductive film having a low electric resistance value cannot be obtained. In other words, even in the case where the least amount of binder is used, 100 parts by weight of the binder is used with respect to 500 parts by weight of the inorganic conductive powder. This corresponds to an amount of about 110 parts by volume of the binder with respect to 100 parts by volume of the conductive powder when converted into volume on the basis of the density of the binder disclosed in the Publication.

For example, Japanese Laid-open Patent Publication No. 8-199096(1996) discloses a method in which a conductive film forming paint comprising a tin-doped indium oxide (ITO) powder, a solvent, a coupling agent and an organic or inorganic acid salt of metal, and not containing a binder is applied onto a glass plate and calcined at a temperature higher than 300° C. In this method, since a binder is not used, the conductive film will have a low electric resistance value. However, since a calcining step at a temperature higher than 300° C. must be carried out, it is difficult to form a conductive film on a support such as a resin film. In other words, the resin film will be melted, carbonized, or burnt by the high temperature. Although it depends on the type of the resin film, the temperature of 130° C. may be a limit in the case of polyethylene terephthalate (PET) film, for example.

Japanese Patent Publication No. 2994764(B2)(1999) discloses a production method of a transparent conductive film, wherein a paste made in such a way that super-fine particle powder of ITO is dispersed in a solvent together with a resin is applied onto a resin film, and is subjected to a rolling process by a steel roller, after drying.

Japanese Laid-open Patent Publication No. 7-235220(1995) discloses a method comprising the steps of applying a dispersion liquid, which contains conductive fine particles such as ITO and which does not contain a binder, onto a glass substrate; slowly drying the dispersion liquid; applying an overcoat liquid made of silica sol onto the obtained ITO film; and then drying or calcining after drying. According to the aforesaid Publication, the overcoat film made of silica sol is dried for hardening and shrinking, and the ITO fine particles in the ITO film are brought into firm contact with each other by a hardening-shrinking stress at that time. If the contact between the ITO fine particles is insufficient, the electric resistance of the conductive film is high. In order to obtain a large hardening-shrinking stress, the overcoat film must be subjected to a drying process at a high temperature of 150 to 180° C. However, when the substrate is a resin film, the resin film will be deformed by such a high temperature.

Also, according to the aforesaid Publication, the overcoat made of silica sol contributes to bonding of the conductive film and the glass substrate as well. Namely, the strength of the conductive film is obtained by the overcoat made of silica sol. However, the electric resistance of the conductive film is high and the strength of the film is small unless the application and the hardening-shrinking of the overcoat liquid is carried out. Furthermore, in order to improve the optical characteristics of the conductive film and to reduce the surface resistance, the drying step after application of the dispersion liquid of the conductive fine particles on the glass substrate must be carried out slowly. There is a disadvantage in that cracks may be generated in the overcoat film made of silica sol if the thickness of the film is large.

As a method other than the application method, Japanese Laid-open Patent Publication No. 6-13785(1994) discloses a conductive coating film composed of a compressed powder layer in which at least a part of the voids, preferably the whole of the voids, of a skeleton structure constructed with a conductive substance (metal or alloy) powder is filled with resin, and a resin layer located therebelow. The production method thereof will be described with reference to a case in which a coating film is formed on a plate material as an example. According to the Publication, first a resin, a powder substance (metal or alloy), and a plate material serving as a member to be treated are oscillated or stirred in a container together with a coating film forming medium (steel balls having a diameter of several millimeters), whereby a resin layer is formed on a surface of the member to be treated. Successively, the powder substance is captured and fixed to the resin layer by an adhesive force of the resin layer. Further, the coating film forming medium receiving the oscillation or stirring gives a hitting force to the powder substance receiving the oscillation or stirring, whereby a compressed powder layer is formed. In order to obtain an effect of fixing the compressed powder layer, a considerable amount of the resin is required. Also, the production method is cumbersome as compared with the application method.

As a method other than the application method, Japanese Laid-open Patent Publication No. 9-107195(1997) discloses a method in which a conductive short fiber is sprinkled and deposited on a film such as PVC, followed by a pressing treatment to form an integrated layer of the conductive fiber and the resin. The conductive short fiber is one obtained by depositing a nickel plating or the like on a short fiber such as polyethylene terephthalate. The pressing operation is preferably carried out under a temperature condition in which the resin matrix layer shows thermoplasticity, and it discloses a high-temperature and low-pressure condition of 175° C. and 20 kg/cm^{2.}

From these backgrounds, it is desired to develop a method in which a transparent conductive film having a low electric resistance value is obtained while utilizing the advantages of the application method that a conductive film of large area can be easily formed, that the apparatus is simple and has a high productivity, and that the conductive film can be produced at a low cost.

### SUMMARY OF THE INVENTION

Thus, an object of the present invention is to provide a transparent electrical conductive film having a low electric resistance value and little scattering by the application method and to provide a method of producing a transparent electrical conductive film in which a film having a low electric resistance value and little scattering is obtained by the application method. Further, an object of the present invention is to provide a method of producing a transparent electrical conductive film in which a film can be formed without a heating treatment of high temperature and a uniform film without thickness unevenness can be obtained, and a method of producing a transparent electrical conductive film that can meet the increase in the area of the film.

Conventionally, in the application method, it was considered that a conductive film cannot be formed without the use of a large amount of binder resin or, in the case where binder resin is not used, the conductive film cannot be obtained unless a conductive substance is sintered at a high temperature.

Nevertheless, surprisingly as a result of the eager studies made by the present inventor, it has been found out that a transparent conductive film having a mechanical strength, a low electric resistance value, and little scattering can be obtained by compression even without the use of a large amount of resin serving as a binder and without calcining at a high temperature, thereby arriving at the present invention.

The present invention is a transparent electrical conductive film comprising a compressed layer of conductive fine particles obtained by compressing a layer containing conductive fine particles that is formed by application onto a support,

wherein the compressed layer of the conductive fine particles contains a resin at the time of compression, the resin being contained at an amount of 73 parts by volume or less with respect to 100 parts by volume of the conductive fine particles as represented by volume, and

the compressed layer of the conductive fine particles is impregnated with a transparent substance after compression.

The compressed layer of the conductive fine particles preferably contains, at the time of compression, 55 parts by volume or less of the resin with respect to 100 parts of the conductive fine particles by volume as represented by volume.

The layer containing the conductive fine particles is formed by applying a dispersion liquid, which contains the conductive fine particles and the resin, onto the support and drying the liquid, the resin being contained at an amount of 73 parts by volume or less with respect to 100 parts by volume of the conductive fine particles in the dispersion liquid as represented by volume before dispersion.

The dispersion liquid of the conductive fine particles more preferably contains 55 parts by volume or less of the resin with respect to 100 parts by volume of the conductive fine particles as represented by volume before dispersion.

In the transparent conductive film, the support is preferably a film made of resin.

Also, the present invention is a method of producing a transparent electrical conductive film, comprising the steps of:

applying a dispersion liquid on a support and drying the liquid, the dispersion liquid containing conductive fine particles and a resin, the resin being contained at an amount of 73 parts by volume or less with respect to 100 parts by volume of the conductive fine particles in the dispersion liquid as represented by volume before dispersion, thereby to form a layer containing the conductive fine particles; and then

compressing the layer containing the conductive fine particles to form a compressed layer of the conductive fine particles; and further

impregnating the formed compressed layer of the conductive fine particles with a transparent substance.

In the aforesaid method, the layer containing the conductive fine particles is preferably compressed at a compression force of at least 44 N/mm^{2.}

In the aforesaid method, the layer containing the conductive fine particles is preferably compressed at such a temperature that said support is not deformed.

In the aforesaid method, the layer containing the conductive fine particles is preferably compressed using a roll press machine.

According to the present invention, a transparent conductive film is obtained by a simple operation of applying a conductive paint onto a support, compressing it, and followed by impregnation with a transparent substance. The transparent conductive film according to the present invention has an excellent conductivity and a super excellent transparency. Further, the close adhesion between the conductive layer and the support is firm, so that the transparent conductive film can be used for a long period of time.

Also, according to the method of the present invention, it can meet an increase in the area of the conductive film, the apparatus is simple and has a high productivity, and various functional films including a conductive film can be produced at a low cost.

### BRIEF DESCRIPTION OF THE DRAWINGS

FIG. 1 is a view for describing a 90° peel test in the Examples of the present invention.

FIG. 2 is a plan view schematically illustrating a masking film used in Examples of the present invention.

FIG. 3 is a plan view schematically illustrating an exemplary transparent conductive film fabricated in Examples of the present invention.

FIG. 4 is a perspective view schematically illustrating an exemplary transparent conductive film fabricated in Examples of the present invention.

### DETAILED DESCRIPTION OF THE INVENTION

In the present invention, a dispersion liquid containing conductive fine particles and a resin is used as a conductive paint. The conductive fine particles are not particularly limited as long as they do not deteriorate the transparency of the conductive film, and any of inorganic conductive fine particles or organic conductive fine particles can be used. Usually, inorganic conductive fine particles may be used.

In the present invention, transparency means transmittance of visible light. With respect to the degree of scattering of light, desired level differs depending on the usage of the conductive film. In the present invention, those generally referred to as being translucent and having a scattering are also included. However, by impregnating the compressed layer of the conductive fine particles with a transparent substance, the conductive film of the present invention has the extremely reduced scattering of light and excellent transparency, namely, has a low haze value.

As the inorganic conductive fine particles, there are tin oxide, indium oxide, zinc oxide, cadmium oxide, and others, and fine particles of antimony doped tin oxide (ATO), fluorine doped tin oxide (FTO), tin doped indium oxide (ITO), aluminum doped zinc oxide (AZO), and the like are preferable. Further, ITO is preferable in view of obtaining a more excellent conductivity. Alternatively, those in which the surface of fine particles such as barium sulfate having transparency is coated with an inorganic material such as ATO, ITO, or the like can be used. The particle diameter of these fine particles is different depending on the degree of scattering required in accordance with the usage of the conductive film, and may generally vary depending on the shape of the particles; however, it is generally at most 1.0 μm, preferably at most 0.1 μm, more preferably from 5 nm to 50 nm.

The resin to be used in the present invention is not particularly limited, and thermoplastic resin or rubber elastic polymers having excellent transparency can be used either alone or as a mixture of two or more kinds thereof. Examples of the resin include fluoro-type polymers, silicone resin, acrylic resin, polyvinyl alcohol, carboxymethyl cellulose, hydroxypropyl cellulose, regenerated cellulose, diacetyl cellulose, polyvinyl chloride, polyvinyl pyrrolidone, polyethylene, polypropylene, SBR, polybutadiene, polyethylene oxide, and others.

As the fluoro-type polymers, polytetrafluoroethylene, polyvinylidene fluoride (PVDF), vinylidene fluoride-ethylene trifluoride copolymer, ethylene-tetrafluoroethylene copolymer, propylene-tetrafluoroethylene copolymer, and others may be mentioned. Also, fluorine-containing polymers in which hydrogen of the main chain is substituted with an alkyl group can be used. The larger the density of the resin is, the smaller the volume is even if a large weight is used, so that it is more likely to satisfy the requirements of the present invention.

In the present invention, the resin is used in an amount of 73 parts by volume or less with respect to 100 parts by volume of the conductive fine particles as represented by volume before dispersion. The resin has a function of reducing the scattering of the conductive film; however, on the other hand, it raises the electric resistance value of the conductive film. This is because the contact between the conductive fine particles is inhibited by the insulating resin and, if the amount of resin is large, the fine particles do not contact with each other, so that the movement of electrons among the fine particles is inhibited. Therefore, the resin is used in the aforesaid volume range in view of ensuring of conductivity among the conductive fine particles.

If the amount of resin is within this range, the electric resistance value of the conductive film decreases if the compression pressure in the compressing step is increased. This seems to mean that, according as the compression pressure is increased, the conductive fine particles are brought into better contact with each other. In this case, since the amount of resin is small, it seems that almost all of the resin is present in the voids among the conductive fine particles in the compressed layer of the conductive fine particles. However, if a larger amount of resin is used, there appears a tendency such that the electric resistance value of the conductive film increases conversely according as the compression pressure in the compressing step is increased. This seems to be because, according as the compression pressure is increased, the resin is forced into a gap between the conductive fine particles to cause a behavior such that the conductive fine particles are separated from each other, since the amount of resin is large.

In the present invention, in view of conductivity, the resin is preferably used in an amount of 55 parts by volume or less, more preferably 37 parts by volume or less, still more preferably less than 18.5 parts by volume, with respect to 100 parts by volume of the conductive fine particles as represented by volume before dispersion.

In the present invention, the compressed layer is impregnated with a transparent substance after the compressed layer of conductive fine particles is formed, so that the scattering of the conductive films is greatly reduced.

In the present invention, the volume of the conductive fine particles and the volume of the resin are not an apparent volume but a true volume. The true volume is determined by determining the density with the use of an apparatus such as a pycnometer based on JIS (Japanese Industrial Standard) Z 8807 and dividing the weight of the material to be used with the density. The reason why the amount of use of the resin is defined not by weight but by volume is that an actual state is more reflected by the volume when one considers how the resin is present in relation to the conductive fine particles in the conductive film obtained after compression.

The liquid for dispersing the conductive fine particles and the resin is not particularly limited and various already known solvents can be used as long as the resin is dissolved therein. For example, as the solvent, saturated hydrocarbons such as hexane, aromatic hydrocarbons such as toluene and xylene, alcohols such as methanol, ethanol, propanol and butanol, ketones such as acetone, methyl ethyl ketone, methyl isobutyl ketone and diisobutyl ketone, esters such as ethyl acetate and butyl acetate, ethers such as tetrahydrofuran, dioxane and diethyl ether, amides such as N,N-dimethylformamide, N-methylpyrrolidone (NMP) and N,N-dimethylacetamide, halogenated hydrocarbons such as ethylene chloride and chlorobenzene, and others may be mentioned. Among these, solvents having a polarity are preferable, and alcohols such as methanol and ethanol, and amides such as NMP are suitable. These solvents can be used either alone or as a mixture of two or more kinds thereof. Further, a dispersant may be used in order to improve the dispersion of the conductive fine particles.

Also, water can be used as the solvent. If water is used as the solvent, the support must be hydrophilic. The resin film is usually hydrophobic and is water-repellent, so that a uniform film is not likely to be obtained. In the case where the support is a resin film, it is necessary to mix an alcohol with water or to make a hydrophilic surface of the support. Further, it is preferable to consider the solubility of the resin as well.

The amount of the solvent to be used is not particularly limited, and may be such that the dispersion liquid of the conductive fine particles has a viscosity suitable for application methods as mentioned later. For example, 100 to 100,000 parts by weight of solvent is used with respect to 100 parts by weight of the conductive fine particles. The amount of the solvent may be suitably selected in accordance with the type of the conductive fine particles and the solvent. Generally, according as the particle diameter of the fine particles becomes small, the specific surface area of the fine particles becomes large, thereby the viscosity of the dispersion liquid tends to become high. When the fine particles having large specific surface area are used, a larger amount of the solvent is preferably used to reduce the solid concentration in the dispersion liquid. Further, when the intended thickness of the coating film is small, the dispersion liquid with a low solid concentration by using a larger amount of the solvent is preferably used.

The dispersion of the conductive fine particles into the liquid may be carried out by a known dispersion technique. For example, the dispersion is carried out by the sand grinder mill method. At the time of dispersion, use of a medium such as zirconia beads is also preferable in order to loosen the agglomeration of the fine particles. Further, at the time of dispersion, one must take care not to mix impurities such as dust.

Various additives may be blended with the dispersion liquid of the conductive fine particles within a range that does not decrease the conductivity. For example, additives such as an ultraviolet absorber, a surfactant, a dispersant, and the like may be blended.

The support is not particularly limited, and various ones such as resin film, glass, ceramics, and others may be used. However, glass, ceramics, or the like has a high possibility of cracking in a later step of compression, so that one has to take this into account.

Therefore, the support is preferably a resin film that is not cracked even if the compression force of the compression step is increased. As mentioned later, the resin film is preferable in view of good close adhesion of the conductive fine particle layer to the film, and is also suitable for usage that requires weight reduction. In the present invention, since a pressing step at a high temperature or a calcining step is not carried out, the resin film can be used as the support.

As the resin film, for example, polyester film such as polyethylene terephthalate (PET), polyolefin film such as polyethylene or polypropylene, polycarbonate film, acrylic film, norbornene film (Arton manufactured by JSR Co., Ltd., or the like), and others may be mentioned.

In the case of a resin film such as PET film, a part of the conductive fine particles that are in contact with the PET film is “buried” in the PET film in the compression step after drying, whereby the conductive fine particle layer closely adheres to the PET film well.

In the case of a hard substance such as glass or a resin film having a hard film surface, the conductive fine particles are not buried, thereby failing to provide close adhesion between the fine particle layer and the support. In such a case, it is preferable to form a soft resin layer in advance on the glass surface or hard film surface, and then apply, dry, and compress the conductive fine particles. The soft resin layer may be hardened by heat or ultraviolet rays after compression. The soft resin layer is preferably insoluble to the liquid in which the conductive fine particles are dispersed. If the resin layer is dissolved, the solution containing the resin comes around the conductive fine particles by capillary phenomenon and, as a result, raises the electric resistance value of the obtained conductive film.

The dispersion liquid of the conductive fine particles is applied onto the support and dried to form a layer containing the conductive fine particles.

The application of the dispersion liquid of the conductive fine particles onto the support is not particularly limited, and may be carried out by a known method. For example, the application of the dispersion liquid having a high viscosity of 1,000 cps or more may be carried out by the application methods such as the blade method, the knife method, or the like. The application of the dispersion liquid having a low viscosity of less than 500 cps may be carried out by the application methods such as the bar coat method, the kiss coat method, the squeeze method, or the like. Also, in case of the dispersion liquid having a low viscosity, the dispersion liquid can be allowed to adhere onto the support by atomizing, spraying, or the like. Further, independently of viscosity of the dispersion liquid, it is possible to use the application methods such as the reverse roll method, the direct roll method, the extrusion nozzle method, the curtain method, the gravure roll method, the dip method, or the like.

The drying temperature is preferably about 10 to 150° C. although it depends on the type of the liquid used for dispersion. If the temperature is lower than 10° C., condensation of moisture in air is liable to occur, whereas if it exceeds 150° C., the resin film support will be deformed. Also, at the time of drying, one must take care not to allow impurities to adhere to the surface of the conductive fine particles.

The thickness of the layer containing the conductive fine particles after application and drying may be about 0.1 to 10 μm, though it depends on the compression condition in the next step or on the usage of the final conductive film.

Thus, if the conductive fine particles are dispersed in liquid for application and drying, it is easy to form a uniform film. If dispersion liquid of the conductive fine particles is applied and dried, the fine particles form a film even if a large amount of binder resin is not present in the dispersion liquid as in a conventional case, i.e. even if the amount of resin is smaller than a specific amount as in the present invention. The reason why the film is formed even in the absence of a large amount of binder resin is not necessarily clear; however, when the amount of liquid decreases by drying, the fine particles gather by a capillary force. Further, it seems that, since they are fine particles, the specific surface area is large and the agglomeration force is strong to form a film. However, the strength of the film at this stage is weak. Also, as a conductive film, it has a high resistance value and has a large variation of resistance value.

Next, the formed layer containing the conductive fine particles is compressed to obtain a compressed layer of conductive fine particles. The compression reduces the electric resistance and improves the strength of the film. Namely, the compression increases the number of contact points among the conductive fine particles to increase the contact area. For this reason, the electric resistance is reduced and the coating film strength is increased. Since the fine particles are originally liable to be agglomerated, the compression makes a firm film. Also, the compression improves the haze.

The compression is preferably carried out at a compression force of at least 44 N/mm². If it is carried out at a low pressure of less than 44 N/mm², the layer containing the conductive fine particles cannot be fully compressed, and it is difficult to obtain a conductive film being excellent in conductivity. A compression force of at least 183 N/mm² is more preferable. According as the compression force is higher, a film being more excellent in conductivity is obtained, the strength of the conductive film is improved, and the close adhesion between the conductive layer and the support will be firm. According as the compression force is raised, the pressure resistance of the apparatus must be raised, so that a compression force up to 1000 N/mm² is generally suitable.

Further, the compression is preferably carried out at such a temperature that the support is not deformed. If the support is resin film, for example, it will be a temperature range below the glass transition temperature (secondary transition temperature) of the resin.

The compression is not particularly limited and may be carried out by sheet press or roll press; however, it is preferably carried out by means of a roll press machine. The roll press is a method in which the film to be compressed is sandwiched between rolls for compression and the rolls are rotated. The roll press is suitable because a high uniform pressure can be applied in the roll press, and the productivity of the roll press is higher than that of the sheet press.

The roll temperature of the roll press machine is preferably an ordinary temperature (an environment suitable for human work) from the viewpoint of productivity. If the compression is carried out in a heated atmosphere or with heated rolls (hot press), there will be a disadvantage such that the resin film is elongated when the compression pressure is increased. If the compression pressure is reduced in order to prevent the resin film from being elongated under heating, the mechanical strength of the coating film decreases and the electric resistance rises. It is also preferable to control the temperature so that the roll temperature may not rise by heat generation in the case where continuous compression is carried out by means of a roll press machine.

If there is a reason to reduce the adhesion of moisture to the fine particle surface as much as possible, the heated atmosphere may be adopted in order to reduce the relative humidity of the atmosphere; however, the temperature range is within a range such that the film is not easily elongated. Generally, it will be a temperature range below the glass transition temperature (secondary transition temperature). By taking the variation of humidity into account, it may be set at a temperature which is a little higher than the temperature that achieves the required humidity.

Here, the glass transition temperature of the resin film is determined by measuring the dynamic viscoelasticity, and refers to the temperature at which the dynamic loss of the main dispersion is at its peak. For example, with regard to PET film, its glass transition temperature is approximately around 110° C.

The roll of the roll press machine is preferably a metal roll because a strong pressure can be applied. Also, if the roll surface is soft, the fine particles may be transferred to the rolls at the compressing time, so that the roll surface is preferably treated with a hard film such as hard chromium, spraying film of ceramics, a film obtained by ionic plating Of TiN etc., DLC(diamond like carbon), or the like.

In this manner, the compressed layer of the conductive fine particles is formed. The thickness of the compressed layer of the conductive fine particles may be about 0.05 to 10 μm, preferably 0.1 to 5 μm, more preferably 0.1 to 3 μm, and most preferably 0.1 to 2 μm, though it depends on the usage. The compressed layer of the conductive fine particles contains 73 parts by volume or less of the resin with respect to 100 parts by volume of the conductive fine particles in accordance with the volume ratio of the conductive fine particles to the resin used in preparing the dispersion liquid.

Further, in order to obtain a compressed layer having a thickness of about 10 μm, a series of operations including application, drying, and compression of the dispersion liquid of the conductive fine particles may be carried out repeatedly. Furthermore, in the present invention, it is of course possible to form a conductive film on both surfaces of the support.

The transparent conductive film thus obtained shows an excellent conductivity, has a practically sufficient film strength even though it is made without the use of a large amount of binder resin as in the conventional case, and also has an excellent close adhesion with the support.

Next, the obtained compressed layer of the conductive fine particles is impregnated with a transparent substance.

The obtained compressed layer of the conductive fine particles may generate scattering of light because it is a porous film. By impregnating the compressed layer with a transparent substance, the scattering of light can be reduced. Namely, the obtained conductive film has a low electric resistance and little scattering of light, since the voids in the compressed layer is impregnated with a transparent substance after the compressed layer of the conductive fine particles having a low electric resistance is formed.

In the present invention, impregnation with a transparent substance refers to allowing an impregnation liquid containing a transparent substance (or its precursor) to permeate into voids in the porous compressed layer of conductive fine particles, and thereafter solidifying the permeated transparent substance by a suitable method. Alternatively, the liquid used for impregnation may be present as it is, depending on the usage of the conductive film.

The transparent substance to be used for impregnation is not particularly limited, and substances such as organic polymers, intermediates of organic polymers, oligomers, monomers, and the like may be mentioned. Specifically, organic polymers such as fluoropolymer, silicone resin, acrylic resin, polyvinyl alcohol, carboxymethylcellulose, hydroxypropylcellulose, regenerated cellulose, diacetylcellulose, polyvinyl chloride, polyvinyl pyrrolidone, polyethylene, polypropylene, SBR, polybutadiene, polyethylene oxide, polyester, polyurethane, and others may be mentioned. The compressed layer may be impregnated with a precursor (monomer or oligomer) of these organic polymers, and the precursor may be converted into these organic polymers by carrying out an ultraviolet ray treatment or a heat treatment after impregnation.

Further, inorganic substances, glass, or the like may be used, if the substances can be in the liquid state in the time of impregnation. If the temperature of the impregnation liquid is high, a support which is unaffected by the high temperature may be used.

When resin film is used as the support, as the transparent substance to be used for impregnation, one may use an inorganic substance capable of forming a film at a low temperature such that the support resin film is not affected. For example, titanium peroxide, tungsten peroxide, and others may be used. An impregnation liquid obtained by dissolving titanium peroxide into water is applied onto the compressed layer, water is dried, and a heat treatment is carried out at about 100° C. to form titanium oxide. Alternatively, a solution of metal alkoxide may be applied onto the compressed layer by the sol-gel method, and a heat treatment may be carried out at a low temperature about 100° C. to form a metal oxide. Polysilazane may be used. Also, the compressed layer may be impregnated with liquid such as silicone oil.

The transparent substance to be used for impregnation does not necessarily have a property of hardening-shrinking, and can be selected from a variety of transparent substances.

When ceramics is used as the support, molten glass may be used for impregnation.

The impregnation liquid can be obtained by dissolving a transparent substance or its precursor into a suitable solvent. The solvent is not particularly limited and various kinds of already known liquids can be used. For example, saturated hydrocarbons such as hexane, aromatic hydrocarbons such as toluene and xylene, alcohols such as methanol, ethanol, propanol and butanol, ketones such as acetone, methyl ethyl ketone, methyl isobutyl ketone and diisobutyl ketone, esters such as ethyl acetate and butyl acetate, ethers such as tetrahydrofuran, dioxane and diethyl ether, amides such as N,N-dimethylformamide, N-methylpyrrolidone (NMP) and N,N-dimethylacetamide, halogenated hydrocarbons such as ethylene chloride and chlorobenzene, water, and others may be mentioned. For facilitating the impregnation, it is preferable to adjust the viscosity of the impregnation liquid.

Further, if the transparent substance or its precursor is in a liquid form such as a monomer or oligomer, the transparent substance or its precursor may be used, as it is, as the impregnation liquid without dissolving it into a solvent. Alternatively, for facilitating the impregnation, the impregnation liquid may be prepared by diluting the transparent substance or its precursor with a suitable solvent.

Various additives may be blended with the impregnation liquid. For example, additives such as an ultraviolet absorber, an infrared absorber, and a colorant may be blended.

The impregnation with the transparent substance can be carried out by a method such as application of the impregnation liquid onto a surface of the compressed layer of the conductive fine particles or immersion of the compressed layer into the impregnation liquid. Since the compressed layer is porous, the impregnation liquid penetrates into voids by a capillary force.

The application of the impregnation liquid onto the compressed layer of the conductive fine particles is not particularly limited, and may be carried out by a known method. For example, it may be carried out by an application method such as the reverse roll method, the direct roll method, the blade method, the knife method, the extrusion nozzle method, the curtain method, the gravure roll method, the bar coat method, the dip method, the kiss coat method, the squeeze method, or the like. Also, the impregnation liquid can be allowed to adhere onto the compressed layer for permeation by atomizing or spraying.

After allowing the impregnation liquid to permeate into voids in the compressed layer, the permeated transparent substance is solidified by a suitable method. For example, it is possible to apply a method of solidifying the transparent substance by drying the solvent after impregnation, a method of drying the solvent after impregnation and then hardening the organic polymer and/or the monomer and/or the oligomer by carrying out an ultraviolet ray treatment or a heat treatment, a method of carrying out a heat treatment on the metal peroxide or metal alkoxide at a temperature up to about 100° C. to form a metal oxide after impregnation, or the like method. A suitable method is adopted in accordance with the transparent substance that is put to use.

The amount of the impregnation liquid to be applied onto the compressed layer of the conductive fine particles is suitably selected in accordance with the usage of the conductive film. For example, if one wishes to bring the whole surface of the conductive film into a state capable of electrical contact, the amount of the impregnation liquid may be such as to fill the voids in the compressed layer. Alternatively, a protective layer of the transparent substance may be formed on the compressed layer simultaneously with the impregnation by applying the impregnation liquid in an amount more than needed in filling the voids in the compressed layer. In this case, the thickness of the protective layer is typically about 0.1 μm to 100 μm. The amount of the impregnation liquid to be applied may be selected in accordance with the thickness of the protective layer.

Further, if one wishes to leave a conductive portion in a desired part (typically, an end part) on the surface of the conductive film, a part where the protective layer is not formed may be ensured by a masking treatment or the like. Alternatively, a part of the protective layer may be removed after forming the protective layer.

By such impregnation with a transparent substance, the surface of the compressed layer of the conductive fine particles will have a reduced scattering of light.

### EXAMPLES

Hereafter, the present invention will be described with reference to Examples thereof; however, the present invention is not limited to these Examples alone.

First, an example will be given in which ATO fine particles are used as the conductive fine particles in order to obtain a transparent conductive film for use as a CRT electromagnetic wave shield,

### [Example 1]

1. Formation of Compressed Layer of Conductive Fine Particles

Polyvinylidene fluoride [PVDF, density of 1.8 g/cm³ (the same applies in the following examples and comparative examples)] was used as the resin. A resin solution was prepared by dissolving 10 parts by weight of PVDF into 990 parts by weight of N-methylpyrrolidone (NMP). To 100 parts by weight of ATO fine particles having a primary particle diameter of 10 to 30 nm (density of 6.6 g/cm³, manufactured by Ishihara Sangyo Kaisha Ltd.) were added 1 part by weight of the resin solution and 399 parts by weight of NMP, and dispersion was carried out by means of a dispersion machine with the use of zirconia beads as a medium. The obtained coating solution was applied onto a PET film having a thickness of 50 μm by means of a bar coater and dried (100° C., 3 minutes). The obtained film will be hereafter referred to as an ATO film (A1) before compression. The ATO-containing coating layer had a thickness of 1.7 μm.

First, a preliminary experiment for confirming the compression pressure was carried out.

By means of a roll press machine equipped with a pair of metal rolls having a diameter of 140 mm (whose roll surface had been subjected to hard chromium plating treatment), the aforesaid ATO film (A1) before compression was sandwiched and compressed at room temperature (23° C.) without rotating the rolls and without heating the rolls. At this time, the pressure per unit length in the film width direction was 660 N/mm. Next, the pressure was released and the length of the compressed part in the film length direction was examined and found out to be 1.9 mm. From this result, it is found out that the film had been compressed by a pressure of 347 N/mm² per unit area.

Next, the aforesaid ATO film (A1) before compression, which was the same one as used in the preliminary experiment, was sandwiched between the metal rolls and compressed under the aforesaid condition, and the rolls were rotated to compress the film at a feeding speed of 5 m/min. Thus, a compressed ATO film (B1) was obtained. The ATO coating layer after compression had a thickness of 1.0 μm.

(Electric Resistance and Haze before Impregnation)

The film (B1) having a conductive layer formed thereon was cut into a size of 50 mm×50 mm. The electric resistance was measured by applying a tester to two points on diagonally positioned corners and was found out to be 80 kΩ. Also, the haze was measured by means of a haze meter (TC-H3 DPK type, manufactured by Tokyo Denshoku Technical Center Co., Ltd.) and was found out to be 10%.

(90° peel test)

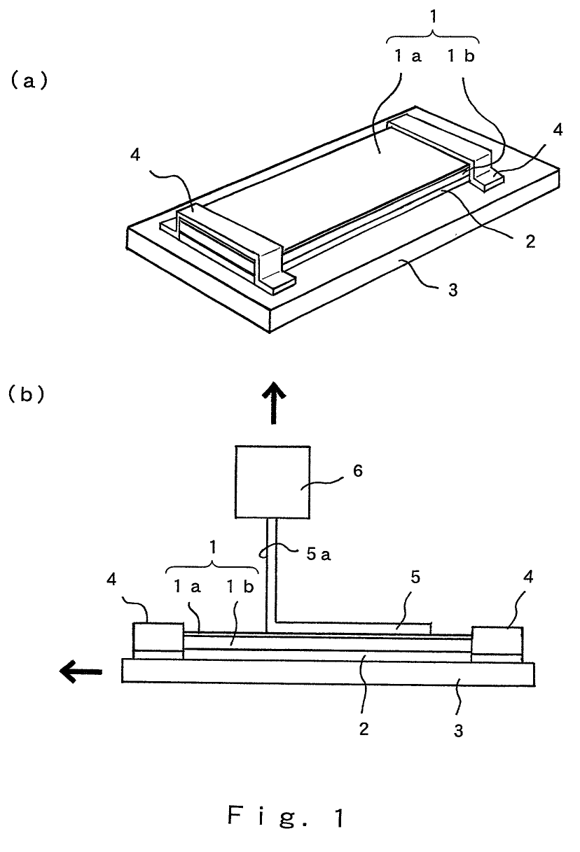

A 90° peel test was carried out in order to evaluate the close adhesion of the conductive layer to the support film and the strength of the conductive layer. An explanation thereof will be given with reference to FIG. 1.

A double-sided adhesive tape (2) was stuck onto a surface of a support film (1b) opposite to the surface having a conductive layer (1a) formed thereon in a test sample (1) having the conductive layer formed. This was cut into a size of 25 mm×100 mm. The test sample (1) was stuck onto a stainless steel plate (3). A cellophane adhesive tape (width 12 mm, No. 29, manufactured by Nitto Denko Corporation) (4) was stuck onto both ends (25 mm sides) of the sample (1) so that the test sample (1) would not be peeled off (FIG. 1(a)).

A cellophane adhesive tape (width 12 mm, No. 29, manufactured by Nitto Denko Corporation) (5) was stuck onto the conductive film (1a) surface of the test sample (1) so that the tape (5) would be parallel to the longitudinal side of the sample (1). The stuck length of the cellophane tape (5) and the sample (1) was 50 mm. The end portion of the tape (5) which was not stuck was attached to a chuck (6), and the test sample (1) was set so that the angle formed between the stuck surface and the non-stuck surface (5a) of the cellophane tape (5) would be 90°. The cellophane tape (5) was pulled and peeled off at a speed of 100 mm/min. At this time, the speed at which the tape (5) was peeled off was made equal to the speed at which the stainless steel plate (3) having the test sample (1) stuck thereon moved so that the angle formed between the non-stuck surface (5a) of the cellophane tape (5) and the test sample (1) surface would always be 90° (FIG. 1(b)). After the test, the state of the coating layer was examined.

∘: No destruction of the coating layer and no peeling-off from the PET film occurred

×: The coating layer was destroyed and a part of the coating layer adhered to the cellophane tape.

From the result of the above 90° peel test, it was found out that the coating layer was not destroyed and was not peeled off from the PET film in the film (B1) of Example 1.

2. Impregnation with a Transparent Substance

(Preparation of Masking Film)

A PET film having a thickness of 5 μm was sandwiched in a roll press machine, and was compressed at a feeding speed of 5 m/min. by rotating rolls with a pressure of 50 N/mm per unit length in the width direction. The PET film was electrically charged by this operation. Referring to FIG. 2, a hole (11a) having a rectangular shape of 40 mm (w₁) in the width direction×60 mm (l₁) in the length direction was drilled approximately at a central part (as viewed in the width direction) of the charged PET film. In the following steps, this was used as a masking film (11).

(Impregnation with a Transparent Substance)

An acrylic resin (0KW-005, manufactured by TAISEI CHEMICAL INDUSTRIES, LTD., concentration of solid components: 50 wt %) was used as the substance for impregnation.

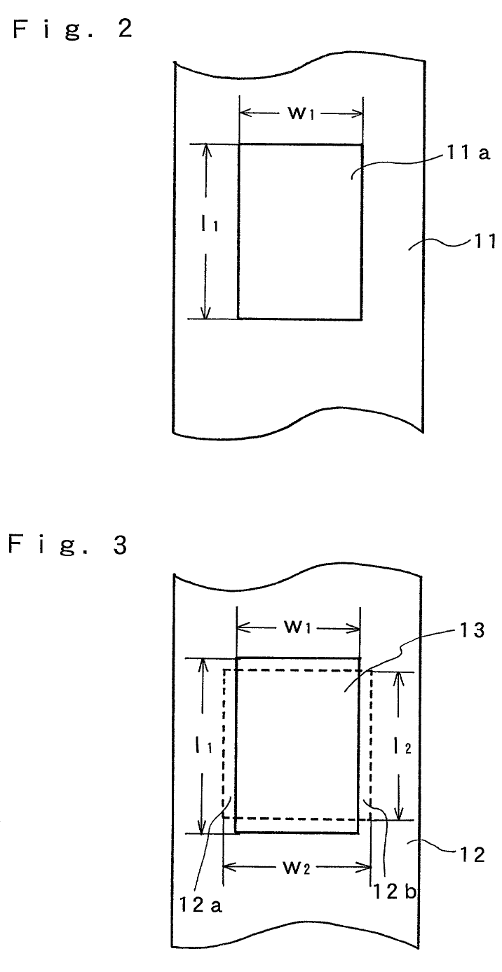

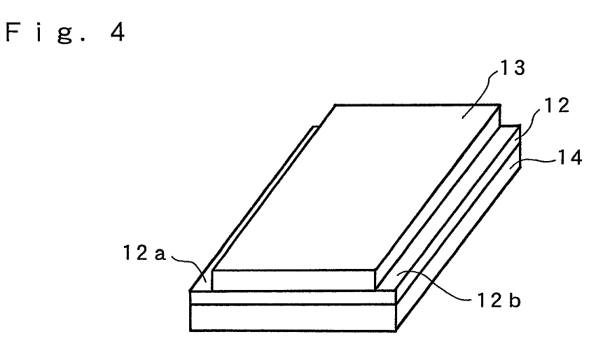

The electrically charged PET film (11) was attached onto the ATO compressed layer surface of the ATO film (B1) obtained in the above step 1. for masking. The impregnation liquid was applied onto the masked ATO film (B1) with the use of a bar coater, the masking film (11) was removed, and the film was dried by supplying hot air of 60° C. Referring to FIG. 3, the ATO compressed layer (12) was impregnated with the acrylic resin, and at the same time, a protective layer (13) having a thickness of 6 μm was formed on the ATO compressed layer (12). Thus, ATO film (C1) impregnated with the transparent substance was obtained.

(Electric Resistance and Haze after Impregnation)

The ATO film subjected to the impregnation treatment was cut into a size of 50 mm (w₂) in the width direction x 50 mm (l₂) in the length direction so that both end parts (12a) (12b) on which the ATO compressed layer (12) surface was exposed would be included in the ATO film, as shown by a broken line in FIG. 3. Thus, a sample of a transparent conductive film of the present invention was obtained such as shown in FIG. 4 (with a support (14) in FIG. 4). The electric resistance was measured by applying a tester to two points on diagonally positioned corners at which the protective layer (13) was not formed, and was found out to be 80 kΩ. The haze of the part (13) subjected to the impregnation treatment was measured and found out to be 2%.

### [Example 2]

A compressed ATO film (B2) was obtained in the same manner as in Example 1 except that the pressure per unit area was changed to 183 N/mm². The ATO coating layer after compression had a thickness of 1.0 μm. The compressed ATO film (B2) had an electric resistance of 130 kΩ and a haze of 11%. From the result of 90° peel test, it was found out that the coating layer was not destroyed and was not peeled off from the PET film.

An impregnated ATO film (C2) was obtained by the impregnation treatment in the same manner as in Example 1. The ATO film (C2) had an electric resistance of 130 kΩ and a haze of 2%.

[Comparative Example 1]

The compression was not carried out in Example 1. Namely, a physical property test was carried out on an ATO film (A1) before compression of Example 1. The ATO film (A1) which had not been subjected to compression treatment had an electric resistance of 6500 kΩ and a haze of 29%. From the result of 90° peel test, it was found out that the peeling-off of the coating layer occurred. The impregnation treatment was carried out.

### [Example 3]

Polyvinylidene fluoride (PVDF) was used as the resin. A resin solution was prepared by dissolving 100 parts by weight of PVDF into 900 parts by weight of NMP. To 100 parts by weight of the same ATO fine particles as used in Example 1 were added 10 parts by weight of the resin solution and 395 parts by weight of NMP, and dispersion was carried out by means of a dispersion machine with the use of zirconia beads as a medium. The obtained coating solution was applied onto a PET film having a thickness of 50 μm by means of a bar coater and dried (100° C., 3 minutes). The ATO-containing coating layer of the ATO film (A3) before compression had a thickness of 1.7 μm.

Thereafter, the same operation as in Example 1 (compression pressure: 347 N/mm²) was carried out to obtain a compressed ATO film (B3). The ATO coating layer after compression had a thickness of 1.0 μm. The compressed ATO film (B3) had an electric resistance of 95 kΩ and a haze of 10%. From the result of 90° peel test, it was found out that the coating layer was not destroyed and was not peeled off from the PET film.

An impregnated ATO film (C3) was obtained by the impregnation treatment in the same manner as in Example 1. The ATO film (C3) had an electric resistance of 95 kΩ and a haze of 2%.

### [Example 4]

A compressed ATO film (B4) was obtained in the same manner as in Example 3 except that the pressure per unit area was changed to 183 N/mm². The ATO coating layer after compression had a thickness of 1.0 μm. An impregnated ATO film (C4) was obtained by the impregnation treatment in the same manner as in Example 3.

[Comparative Example 2]

The compression was not carried out in Example 3. Namely, a physical property test was carried out on an ATO film (A3) before compression of Example 3. The impregnation treatment was carried out.

The following Examples 5 to 16 and Comparative Examples 3 to 14 are examples in which the ratio of the amount of PVDF relative to the amount of the ATO fine particles (the same as the one used in Example 1) used for preparation of the coating solution was changed.

### [Examples 5 to 6, Comparative Example 3]

A resin solution was prepared by dissolving 100 parts by weight of PVDF into 900 parts by weight of NMP. To 100 parts by weight of the ATO fine particles were added 25 parts by weight of the resin solution and 388 parts by weight of NMP, and dispersion was carried out in the same manner as in Example 1. With the use of the obtained coating solution, ATO films were obtained respectively in the same manner as in Examples 1 to 2 and Comparative Example 1 (Example 5: pressure of 347 N/mm², Example 6: pressure of 183 N/mm², Comparative Example 3: without compression). Further, the ATO films were respectively subjected to the impregnation treatment in the same manner as in Example 1, to obtain impregnated ATO films.

### [Examples 7 to 8, Comparative Example 4]

A resin solution was prepared by dissolving 100 parts by weight of PVDF into 900 parts by weight of NMP. To 100 parts by weight of the ATO fine particles were added 50 parts by weight of the resin solution and 375 parts by weight of NMP, and dispersion was carried out in the same manner as in Example 1. With the use of the obtained coating solution, ATO films were obtained respectively in the same manner as in Examples 1 to 2 and Comparative Example 1 (Example 7: pressure of 347 N/mm², Example 8: pressure of 183 N/mm², Comparative Example 14: without compression). Further, the ATO films were respectively subjected to the impregnation treatment in the same manner as in Example 1, to obtain impregnated ATO films.

### [Examples 9 to 10, Comparative Example 5]

A resin solution was prepared by dissolving 100 parts by weight of PVDF into 900 parts by weight of NMP. To 100 parts by weight of the ATO fine particles were added 75 parts by weight of the resin solution and 363 parts by weight of NMP, and dispersion was carried out in the same manner as in Example 1. With the use of the obtained coating solution, ATO films were obtained respectively in the same manner as in Examples 1 to 2 and Comparative Example 1 (Example 9: pressure of 347 N/mm², Example 10: pressure of 183 N/mm², Comparative Example 5: without compression). Further, the ATO films were respectively subjected to the impregnation treatment in the same manner as in Example 1, to obtain impregnated ATO films.

### [Examples 11 to 12, Comparative Example 6]

A resin solution was prepared by dissolving 100 parts by weight of PVDF into 900 parts by weight of NMP. To 100 parts by weight of the ATO fine particles were added 100 parts by weight of the resin solution and 350 parts by weight of NMP, and dispersion was carried out in the same manner as in Example 1. With the use of the obtained coating solution, ATO films were obtained respectively in the same manner as in Examples 1 to 2 and Comparative Example 1 (Example 11: pressure of 347 N/mm², Example 12: pressure of 183 N/mm², Comparative Example 6: without compression). Further, the ATO films were respectively subjected to the impregnation treatment in the same manner as in Example 1, to obtain impregnated ATO films.

### [Examples 13 to 14, Comparative Example 7]

A resin solution was prepared by dissolving 100 parts by weight of PVDF into 900 parts by weight of NMP. To 100 parts by weight of the ATO fine particles were added 150 parts by weight of the resin solution and 325 parts by weight of NMP, and dispersion was carried out in the same manner as in Example 1. With the use of the obtained coating solution, ATO films were obtained respectively in the same manner as in Examples 1 to 2 and Comparative Example 1 (Example 13: pressure of 347 N/mm², Example 14: pressure of 183 N/mm², Comparative Example 7: without compression). Further, the ATO films were respectively subjected to the impregnation treatment in the same manner as in Example 1, to obtain impregnated ATO films.

### [Examples 15 to 16, Comparative Example 8]

A resin solution was prepared by dissolving 100 parts by weight of PVDF into 900 parts by weight of NMP. To 100 parts by weight of the ATO fine particles were added 200 parts by weight of the resin solution and 300 parts by weight of NMP, and dispersion was carried out in the same manner as in Example 1. With the use of the obtained coating solution, ATO films were obtained respectively in the same manner as in Examples 1 to 2 and Comparative Example 1 (Example 15: pressure of 347 N/mm², Example 16: pressure of 183 N/mm², Comparative Example 8: without compression). Further, the ATO films were respectively subjected to the impregnation treatment in the same manner as in Example 1, to obtain impregnated ATO films.

[Comparative Examples 9 to 11]

A resin solution was prepared by dissolving 100 parts by weight of PVDF into 900 parts by weight of NMP. To 100 parts by weight of the ATO fine particles were added 400 parts by weight of the resin solution and 200 parts by weight of NMP, and dispersion was carried out in the same manner as in Example 1. With the use of the obtained coating solution, ATO films were obtained respectively in the same manner as in Examples 1 to 2 and Comparative Example 1 (Comparative Example 9: pressure of 347 N/mm², Comparative Example 10: pressure of 183 N/mm², Comparative Example 11: without compression). Further, the ATO films were respectively subjected to the impregnation treatment in the same manner as in Example 1, to obtain impregnated ATO films.

### [Comparative Examples 12 to 14]

A resin solution was prepared by dissolving 100 parts by weight of PVDF into 900 parts by weight of NMP. To 100 parts by weight of the ATO fine particles were added 1,000 parts by weight of the resin solution and 900 parts by weight of NMP, and dispersion was carried out in the same manner as in Example 1. With the use of the obtained coating solution, ATO films were obtained respectively in the same manner as in Examples 1 to 2 and Comparative Example 1 (Comparative Example 12: pressure of 347 N/mm², Comparative Example 13: pressure of 183 N/mm², Comparative Example 14: not compressed). Further, the ATO films were respectively subjected to the impregnation treatment in the same manner as in Example 1, to obtain impregnated ATO films.

### [Examples 17 to 18]

Examples 17 to 18 are examples in which ITO fine particles that can provide a lower electric resistance than ATO were used as the conductive fine particles in order to obtain a transparent conductive film for use as an electroluminescence panel electrode.

A resin solution was prepared by dissolving 100 parts by weight of PVDF into 900 parts by weight of NMP. To 100 parts by weight of ITO fine particles having a primary particle diameter of 10 to 30 nm (density of 6.9 g/cm³, manufactured by DOWA MINING Co., Ltd.) were added 50 parts by weight of the resin solution and 375 parts by weight of NMP, and dispersion was carried out by means of a dispersion machine with the use of zirconia beads as a medium. The obtained coating solution was applied onto a PET film having a thickness of 50 μm by means of a bar coater and dried (100° C., 3 minutes). The obtained film will be hereafter referred to as an ITO film (A17) before compression.

In the same manner as in Example 1, the ITO film (A17) before compression was compressed at a pressure per unit area of 347 N/mm² (Example 17) or 183 N/mm² (Example 18) and at a feeding speed of 5 m/min, thereby to obtain respective compressed ITO films (B17, B18). The ITO coating layers after compression each had a thickness of 1.0 μm. Further, an impregnated ATO films (C17, C18) were obtained respectively by the impregnation treatment in the same manner as in Example 1.

TABLE 1

| | | | | | Before | | | After | |
|---|---|---|---|---|---|---|---|---|---|
| | | | | | impregnation | | | impregnation | |
| | resin/conductive | | | conductive | electric | | | electric | |
| | fine particles | | | layer | resistance | | 90° | resistance | |
| | weight | volume | pressure | thickness | value | haze | peel | value | haze |
| | ratio | ratio | (N/mm²) | (μm) | (kΩ) | (%) | test | (kΩ) | (%) |
| Example 1 | 0.01/100 | 0.037/100 | 347 | 1.0 | 80 | 10 | ◯ | 80 | 2 |
| Example 2 | 0.01/100 | 0.037/100 | 183 | 1.0 | 130 | 11 | ◯ | 130 | 2 |
| Comparative | 0.01/100 | 0.037/100 | — | 1.7 | 6500 | 29 | X | 5400 | 4 |
| Example 1 | | | | | | | | | |
| Example 3 | 1/100 | 3.7/100 | 347 | 1.0 | 95 | 10 | ◯ | 95 | 2 |
| Example 4 | 1/100 | 3.7/100 | 183 | 1.0 | 140 | 10 | ◯ | 140 | 2 |
| Comparative | 1/100 | 3.7/100 | — | 1.7 | 6400 | 28 | X | 5400 | 4 |
| Example 2 | | | | | | | | | |
| Example 5 | 2.5/100 | 9.3/100 | 347 | 1.0 | 108 | 7 | ◯ | 108 | 2 |
| Example 6 | 2.5/100 | 9.3/100 | 183 | 1.0 | 159 | 9 | ◯ | 159 | 2 |
| Comparative | 2.5/100 | 9.3/100 | — | 1.6 | 6300 | 27 | X | 5400 | 4 |
| Example 3 | | | | | | | | | |
| Example 7 | 5/100 | 18.5/100 | 347 | 1.0 | 121 | 4 | ◯ | 121 | 2 |
| Example 8 | 5/100 | 18.5/100 | 183 | 1.0 | 184 | 7 | ◯ | 184 | 2 |
| Comparative | 5/100 | 18.5/100 | — | 1.4 | 6200 | 25 | X | 5400 | 4 |
| Example 4 | | | | | | | | | |
| Example 9 | 7.5/100 | 28/100 | 347 | 1.0 | 130 | 3 | ◯ | 130 | 2 |
| Example 10 | 7.5/100 | 28/100 | 183 | 1.0 | 194 | 6 | ◯ | 194 | 2 |
| Comparative | 7.5/100 | 28/100 | — | 1.3 | 5900 | 18 | X | 5400 | 3 |
| Example 5 | | | | | | | | | |
| Example 11 | 10/100 | 37/100 | 347 | 1.0 | 135 | 3 | ◯ | 135 | 2 |
| Example 12 | 10/100 | 37/100 | 183 | 1.0 | 200 | 5 | ◯ | 200 | 2 |
| Comparative | 10/100 | 37/100 | — | 1.3 | 5400 | 13 | X | 5300 | 3 |
| Example 6 | | | | | | | | | |

TABLE 2

| | | | | | Before | | | After | |
|---|---|---|---|---|---|---|---|---|---|
| | | | | | impregnation | | | impregnation | |
| | resin/conductive | | | conductive | electric | | | electric | |
| | fine particles | | | layer | resistance | | 90° | resistance | |
| | weight | volume | pressure | thickness | value | haze | peel | value | haze |
| | ratio | ratio | (N/mm²) | (μm) | (kΩ) | (%) | test | (kΩ) | (%) |
| Example 13 | 15/100 | 55/100 | 347 | 1.0 | 190 | 3 | ◯ | 190 | 2 |
| Example 14 | 15/100 | 55/100 | 183 | 1.0 | 250 | 4 | ◯ | 250 | 2 |
| Comparative | 15/100 | 55/100 | — | 1.2 | 5000 | 14 | X | 5000 | 3 |
| Example 7 | | | | | | | | | |
| Example 15 | 20/100 | 73/100 | 347 | 1.0 | 270 | 4 | ◯ | 270 | 2 |
| Example 16 | 20/100 | 73/100 | 183 | 1.0 | 370 | 4 | ◯ | 370 | 2 |
| Comparative | 20/100 | 73/100 | — | 1.2 | 3300 | 17 | ◯ | 3300 | 3 |
| Example 8 | | | | | | | | | |
| Comparative | 40/100 | 147/100 | 347 | 1.0 | 900 | 11 | ◯ | 900 | 2 |
| Example 9 | | | | | | | | | |
| Comparative | 40/100 | 147/100 | 183 | 1.0 | 1000 | 13 | ◯ | 1000 | 2 |
| Example 10 | | | | | | | | | |
| Comparative | 40/100 | 147/100 | — | 1.2 | 1200 | 27 | ◯ | 1200 | 4 |
| Example 11 | | | | | | | | | |
| Comparative | 100/100 | 367/100 | 347 | 1.0 | 7200 | 35 | ◯ | 7200 | 4 |
| Example 12 | | | | | | | | | |
| Comparative | 100/100 | 367/100 | 183 | 1.0 | 6800 | 35 | ◯ | 6800 | 4 |
| Example 13 | | | | | | | | | |
| Comparative | 100/100 | 367/100 | — | 1.2 | 3600 | 41 | ◯ | 3600 | 4 |
| Example 14 | | | | | | | | | |
| Example 17 | 5/100 | 19/100 | 347 | 1.0 | 6 | 3 | ◯ | 6 | 1 |
| Example 18 | 5/100 | 19/100 | 183 | 1.0 | 8 | 4 | ◯ | 8 | 1 |

The results of measurement of Examples 1 to 18 and Comparative Examples 1 to 14 are shown in Table 1 and 2.

The conductive films of Examples 1 to 14 each had a low electric resistance value and a small haze, and was excellent in close adhesion between the conductive layer and the support film and in the conductive layer strength. Further, in the conductive films of Examples 1 to 14, the close adhesion between the conductive layer and the support film and the conductive layer strength after impregnation treatment were equal to those before impregnation treatment.

Thus, if the volume ratio of the resin to the conductive fine particles was 73/100 or less, the electric resistance value was lowered and the haze before impregnation treatment was improved by compression. The haze before impregnation treatment was particularly good if the volume ratio of the resin to the conductive fine particles was within a range from 18/100 to 73/100. The haze was improved by impregnation treatment.

According as the pressing pressure increased, the electric resistance value became lower and the close adhesion between the conductive layer and the support film as well as the conductive layer strength became firm to such an extent that the adhesive of the cellophane tape remained on the conductive surface.

When resin was used in the volume ratio range from 18.5/100 to 37/100 as represented by the volume ratio of resin to the conductive fine particles, the obtained respective conductive films had the close electric resistance values to each other. However, when resin was used in the volume ratio range of less than 18.5/100, there was a noticeable tendency that the electric resistance value decreased remarkably according as resin was used in a smaller amount.

In contrast, in Comparative Examples 9 to 11, since a resin was used in the volume ratio of 147/100 as represented by the volume ratio of resin to the conductive fine particles, the electric resistance value was high even if the compression step was carried out, and there was little decrease in the electric resistance value of the case where the compression step was not carried out.

In Comparative Examples 12 to 14, since a resin was used in the volume ratio of 367/100 as represented by the volume ratio of resin to the conductive fine particles, the electric resistance value increased conversely by carrying out the compression step.

As the conductive fine particles, ITO provided a more excellent conductivity than ATO. Also, the conductive films of Examples 1 to 18 each were excellent in transparency in terms of visible light transmittance.

What is claimed is:

1. A transparent conductive film comprising a compressed layer of conductive fine particles obtained by compressing a layer containing conductive fine particles that is formed by application onto a support,
wherein said compressed layer of the conductive fine particles contains a resin at the time of compression, said resin being contained at an amount of 73 parts by volume or less with respect to 100 parts by volume of said conductive fine particles as represented by volume, and
said compressed layer of the conductive fine particles is impregnated with a transparent substance after compression.

2. The transparent conductive film according to claim 1, wherein said layer containing the conductive fine particles is formed by applying a dispersion liquid, which contains the conductive fine particles and the resin, onto the support and drying the liquid, said resin being contained at an amount of 73 parts by volume or less with respect to 100 parts by volume of said conductive fine particles in said dispersion liquid as represented by volume before dispersion.

3. The transparent conductive film according to claim 1, wherein said support is a film made of resin.

4. A method of producing a transparent conductive film, comprising the steps of:
applying a dispersion liquid on a support and drying the liquid, said dispersion liquid containing conductive fine particles and a resin, said resin being contained at an amount of 73 parts by volume or less with respect to 100 parts by volume of said conductive fine particles in said dispersion liquid as represented by volume before dispersion, thereby to form a layer containing the conductive fine particles; and then
compressing said layer containing the conductive fine particles to form a compressed layer of the conductive fine particles; and further
impregnating said formed compressed layer of the conductive fine particles with a transparent substance.

5. The method of producing a transparent conductive film according to claim 4, wherein said layer containing the conductive fine particles is compressed at a compression force of at least 44 N/mm^{2.}

6. The method of producing a transparent conductive film according to claim 4, wherein said layer containing the conductive fine particles is compressed at such a temperature that said support is not deformed.

7. The method of producing a transparent conductive film according to claim 4, wherein said layer containing the conductive fine particles is compressed using a roll press machine.
